(19) United States
(12) Patent Application Publication
(10) Pub. No.: US 2013/0144450 A1
(43) Pub. Date: Jun. 6, 2013

(54) GENERATOR SYSTEM

(71) Applicant: Akira YASUGI, Tokyo (JP)

(72) Inventor: Akira YASUGI, Tokyo (JP)

(73) Assignee: MITSUBISHI HEAVY INDUSTRIES, LTD., Tokyo (JP)

(21) Appl. No.: 13/399,312

(22) Filed: Feb. 17, 2012

Related U.S. Application Data
(63) Continuation of application No. PCT/JP2011/078134, filed on Dec. 6, 2011.

(51) Int. Cl. G05F 5/00; G05D 17/02

(52) U.S. Cl. 700/287

(57) ABSTRACT

An object is to provide a generator system capable of reducing short-period and long-period output power variations. Provided is a generator system including a pumped-storage power generation facility for leveling a long-period output power variation in a wind turbine; a power storage facility for leveling a short-period output power variation in the wind turbine; and a central control unit that gives control instructions to the wind turbine, the pumped-storage power generation facility, and the power storage facility.

### CROSS REFERENCE TO RELATED APPLICATIONS

This is a continuation of International Application PCT/JP2011/078134, with an international filing date of Dec. 6, 2011, which is hereby incorporated by reference herein in its entirety.

### TECHNICAL FIELD

The present invention relates to a generator system and particularly, to a generator system having a wind turbine.

### BACKGROUND ART

Conventionally known is a generator system in which a wind turbine and an electric storage device are combined and a short-period variation of the output power of the wind turbine is absorbed by the electric storage device, thus realizing stable electric power supply.

Furthermore, a generator system in which a wind turbine and a pumped-storage power generator are combined is disclosed in U.S. Pat. No. 7,239,035.

### CITATION LIST

### Patent Literature

{PTL 1} U.S. Pat. No. 7,239,035

### SUMMARY OF INVENTION

### Technical Problem

Wind turbines exhibit a short-period output power variation and a long-period output power variation. The short-period output power variation can be reduced by an electric storage device, as in conventional techniques. However, since the long-period output power variation is large, in order to reduce the long-period output power variation by using an electric storage device, the electric storage device has to have a large capacity, which is not desirable from an economic standpoint.

An object of the present invention is to provide a generator system capable of reducing both short-period and long-period output power variations.

### Solution to Problem

According to a first aspect, the present invention provides a generator system including: a wind turbine; a variable-output-power generation facility for leveling an output power variation having a long period in the wind turbine; a power storage facility for leveling an output power variation having a short period in the wind turbine; and a central control unit that gives control instructions to the wind turbine, the variable-output-power generation facility, and the power storage facility, in which the output power of the wind turbine, the output power of the variable-output-power generation facility, and the output power of the power storage facility are supplied to a common utility grid; and the long period is a period of several minutes or more, and the short-period is a period shorter than the long period.

According to a second aspect, the present invention provides a generator system including: a wind turbine that has a function for suppressing an output power variation having a short period; a variable-output-power generation facility for leveling an output power variation having a long period in the wind turbine; and a central control unit that gives control instructions to the wind turbine and the variable-output-power generation facility, in which the output power of the wind turbine and the output power of the variable-output-power generation facility are supplied to a common utility grid; and the long period is a period of several minutes or more, and the short-period is a period shorter than the long period.

### Advantageous Effects of Invention

According to the present invention, an advantage is afforded in that short-period and long-period output power variations can be reduced.

### BRIEF DESCRIPTION OF DRAWINGS

FIG. 1 is a diagram showing the entire configuration of a generator system according to one embodiment of the present invention.

FIG. 2 is a functional block diagram showing, among various functions of a central control unit, functions related to control of a pumped-storage power generation facility and a power storage facility.

FIG. 3 is a diagram showing an example table in which wind speed is associated with wind-turbine output power.

FIG. 4 is a diagram showing an example wind-condition prediction input to a wind-turbine output-power predicting section and an example wind-turbine output power corresponding to the wind-condition prediction.

FIG. 5 is a diagram showing an example wind-turbine output power prediction input to a long-period-component extracting section and an example long-period component output from the long-period-component extracting section.

FIG. 6 is a diagram showing example target output power handled by a first-control-instruction generating section.

FIG. 7 is a diagram showing example target output power handled by the first-control-instruction generating section.

FIG. 8 is a diagram showing an example short-period output power variation.

FIG. 9 is a diagram for explaining an effect of gradient power control.

FIG. 10 is a diagram for showing an example configuration of a wind-turbine control unit of a generator system according to another embodiment of the present invention.

FIG. 11 is a diagram for showing an example configuration of a wind-turbine control unit of a generator system according to still another embodiment of the present invention.

### DESCRIPTION OF EMBODIMENTS

A generator system according to one embodiment of the present invention will be described below with reference to the drawings.

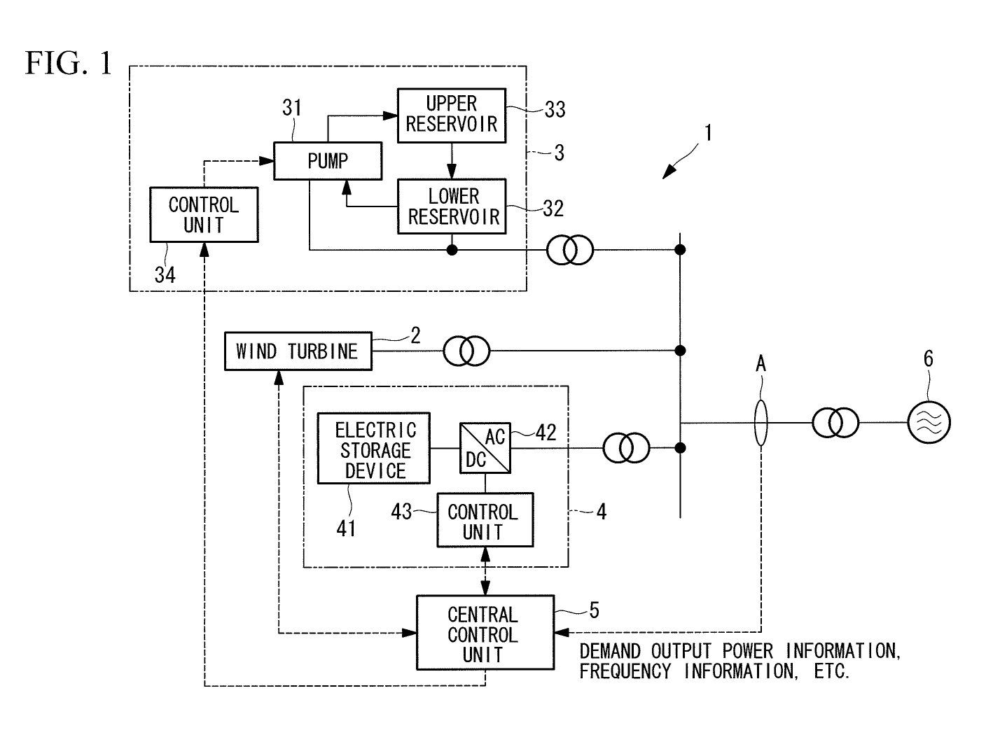

FIG. 1 is a diagram showing the entire configuration of the generator system according to this embodiment. As shown in FIG. 1, a generator system 1 includes, as main components, a wind turbine 2, a pumped-storage power generation facility (variable-output-power generation facility) 3 for leveling a long-period output-power variation in the wind turbine 2, a power storage facility 4 for leveling a short-period output-power variation in the wind turbine 2, and a central control unit 5.

A long period is a period of several minutes or more, for example, and, in this embodiment, it is assumed that a long period is 20 minutes or more. Furthermore, a short period is a period shorter than the long period, and, in this embodiment, it is assumed that a short period ranges from several seconds to several tens of seconds.

The output power from the wind turbine 2, the pumped-storage power generation facility 3, and the power storage facility 4 is supplied to a common utility grid 6 via a common interconnecting point A.

FIG. 1 shows an example case in which one wind turbine 2 is provided, but a plurality of wind turbines 2 may be provided. When a plurality of wind turbines 2 are included, the pumped-storage power generation facility 3 and the power storage facility 4 operate so as to level the long-period output-power variation and the short-period output-power variation, respectively, in the total output power of the plurality of wind turbines 2. Furthermore, a plurality of pumped-storage power generation facilities 3 and a plurality of power storage facilities 4 may be provided.

The pumped-storage power generation facility 3 includes, as main components, a pump 31, a lower reservoir 32, an upper reservoir 33, and a control unit 34. The pumped-storage power generation facility 3 uses the pump 31 to pump water from the lower reservoir 32 to the upper reservoir 33 and drops the water from the upper reservoir 33 into the lower reservoir 32, thereby generating electric power.

When an instruction to consume electric power is received from the central control unit 5, the pump 31 is driven to pump water from the lower reservoir 32 to the upper reservoir 33, thus consuming electric power. When an instruction to supply electric power is received from the central control unit 5, electric power generated by dropping water from the upper reservoir 33 into the lower reservoir 32 is supplied to the utility grid 6. Electric power consumption and electric power generation in the pumped-storage power generation facility 3 are controlled by the control unit 34.

The power storage facility 4 includes an electric storage device 41, such as a battery and a capacitor (condenser), an electric power conversion system 42, and a control unit 43. When an instruction to consume the output power of the wind turbine 2 is received from the central control unit 5, electric power is stored in the electric storage device 41 via the electric power conversion system 42. When an instruction to supply electric power is received from the central control unit 5, the electric power stored in the electric storage device 41 is supplied to the utility grid 6 via the electric power conversion system 42. The electric power conversion system 42 is controlled by the control unit 43.

The central control unit 5 generates an output power instruction for the wind turbine 2 such that, for example, the output power at the interconnecting point A becomes a target electric power, based on frequency information and demand output power information at the interconnecting point A that are notified from a power management office (for example, an electric power company) that manages the utility grid 6, and sends the output power instruction to the wind turbine 2. Thus, the wind turbine 2 controls the output voltage and the output current based on the output power instruction received from the central control unit 5.

Furthermore, the central control unit 5 obtains a prediction of the output power of the wind turbine 2 based on wind-condition prediction information about an area where the wind turbine 2 is installed; calculates, by using this output power prediction, a control instruction for the pumped-storage power generation facility 3 so as to level a long-period output-power variation in the wind turbine 2 and a control instruction for the power storage facility 4 so as to level a short-period output-power variation in the wind turbine 2; and outputs the control instructions to the pumped-storage power generation facility 3 and the power storage facility 4, respectively.

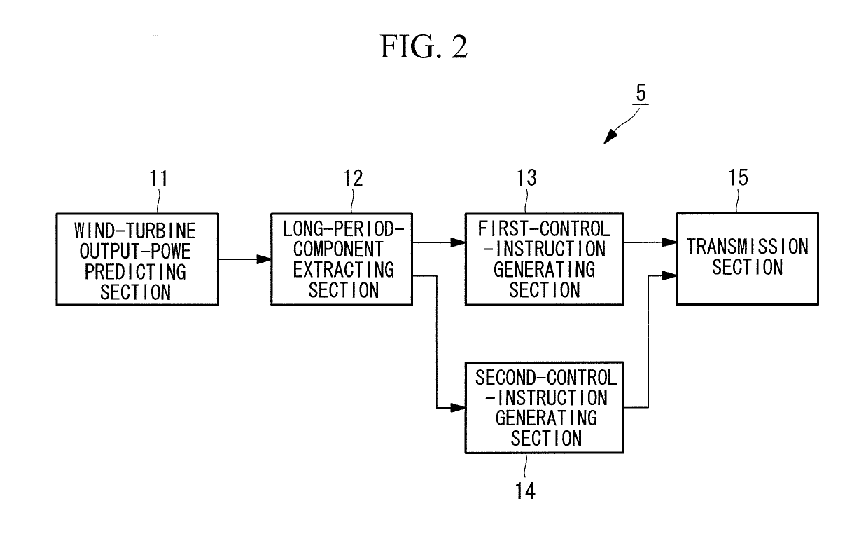

FIG. 2 is a functional block diagram showing, among various functions of the central control unit 5, functions related to control of the pumped-storage power generation facility 3 and the power storage facility 4. As shown in FIG. 2, the central control unit 5 includes a wind-turbine output-power predicting section 11, a long-period-component extracting section 12, a first-control-instruction generating section 13, a second-control-instruction generating section 14, and a transmission section 15.

The wind-turbine output-power predicting section 11 obtains, as input information, wind-condition prediction information about the area where the wind turbine 2 is installed, and predicts the output power of the wind turbine 2 from this wind-condition prediction information. For example, the wind-turbine output-power predicting section 11 repeatedly predicts the output power of the wind turbine 2 from the present time to a certain number of hours from the present time (for example, 12 hours from the present time), at predetermined time intervals.

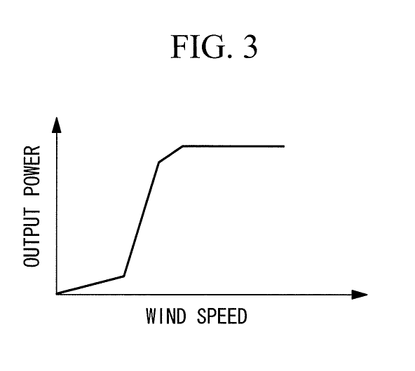

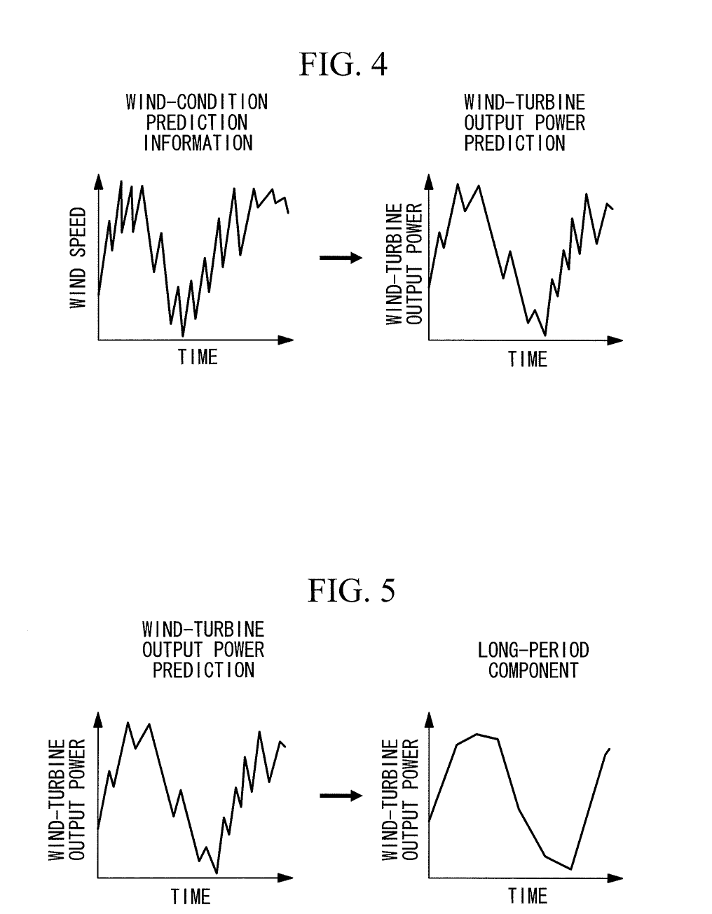

The wind-turbine output-power predicting section 11 has, for example, a table or function in which the wind speed is associated with the wind-turbine output power and predicts the output power of the wind turbine 2 by using this table or function. FIG. 3 is a diagram showing an example table in which the wind speed is associated with the wind-turbine output power. FIG. 4 is a diagram showing an example wind-condition prediction input to the wind-turbine output-power predicting section 11 and an example prediction of the output power of the wind turbine 2 corresponding to the wind-condition prediction.

For example, mesoscale-model wind-condition prediction information provided by a meteorological agency can be used as the wind-condition prediction information. Furthermore, based on meteorological data provided by a meteorological agency and terrain data about the area where the wind turbine 2 is installed, more-highly-accurate wind-condition prediction may be performed in consideration of the terrain, and the wind-condition prediction information thus obtained is adopted.

The long-period-component extracting section 12 extracts a long-period component from the prediction of the output power of the wind turbine 2 obtained by the wind-turbine output-power predicting section 11. For example, the long-period-component extracting section 12 can extract the long-period component by using a low-pass filter. FIG. 5 shows an example prediction of the output power of the wind turbine 2 input to the long-period-component extracting section 12 and an example long-period component output from the long-period-component extracting section 12.

The long-period component extracted by the long-period-component extracting section 12 is output to the first-control-instruction generating section 13 and the second-control-instruction generating section 14.

The first-control-instruction generating section 13 generates a first control instruction that is an output-power control instruction for the pumped-storage power generation facility 3, from the long-period component output from the long-period-component extracting section 12 and the target output power. More specifically, the first-control-instruction generating section 13 generates schedule information in which time is associated with the first control instruction over a given period of time (for example, over 6 hours or 12 hours).

As shown in Formula (1), this schedule information is obtained by subtracting the long-period component from the target output power.

Pc(t)=Pr(t)−Pw_{L}(t) (1)

In Formula (1), Pc(t) indicates the first control instruction, which is the output-power control instruction for the pumped-storage power generation facility 3, Pr(t) indicates the target output power, and Pw_{L}(t) indicates the long-period component extracted by the long-period-component extracting section 12.

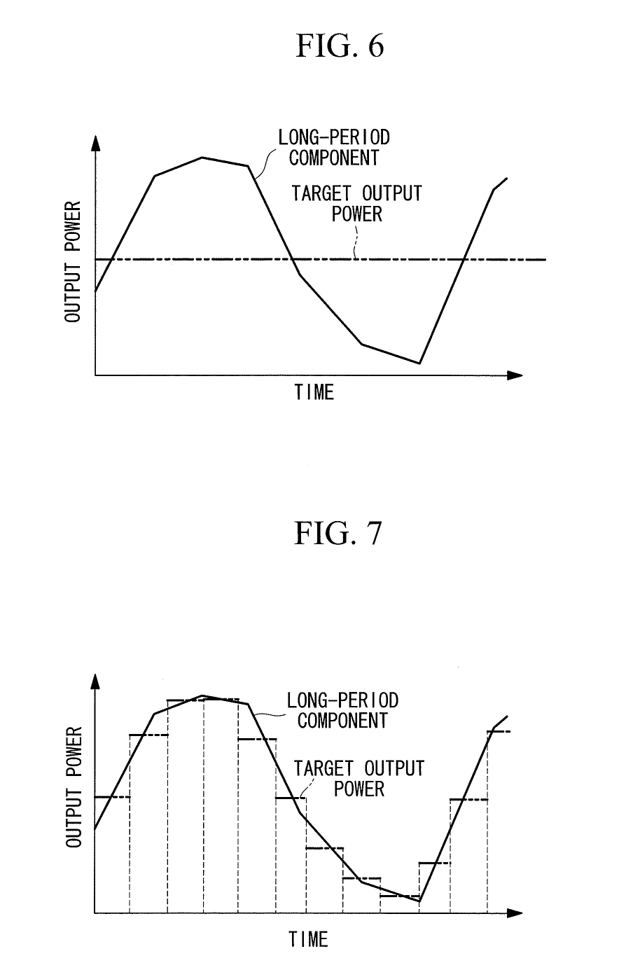

The target output power may be a certain value that is determined in advance, as shown in FIG. 6, or may be a value that is dynamically determined at predetermined intervals based on the long-period component, as shown in FIG. 7. For example, as shown in FIG. 7, the long-period component is divided at the predetermined intervals, and a value obtained by leveling the long-period component at each of the predetermined intervals is specified as a target output power. The period of time corresponding to each of the above-described intervals can be desirably set and may be set to, for example, the control cycle of the pumped-storage power generation facility 3 or may be set based on an instruction from the utility grid side. Furthermore, the length of each of the intervals may be fixed or variable.

The second-control-instruction generating section 14 obtains, as input information, the long-period component from the long-period-component extracting section 12 and the measured output power of the wind turbine 2 and generates, from these pieces of information, a second control instruction that is an output-power control instruction for the power storage facility 4. For example, as shown in Formula (2), the second-control-instruction generating section 14 sets, as the output-power control instruction, a value obtained by subtracting the measured output power of the wind turbine 2 from the long-period component.

Pb(t)=Pw(t)−Pw_{L}(t) (2)

In Formula (2), Pb(t) indicates the second control instruction, which is the output-power control instruction for the power storage facility 4, Pw(t) indicates the measured output power of the wind turbine 2, and Pw_{L}(t) indicates the long-period component extracted by the long-period-component extracting section 12.

The method of calculating the second control instruction is not limited to the above-described example. For example, a known technique in which the electric storage device 41 is used to reduce the short-period output-power variation in the wind turbine 2 can be used.

In this way, unlike the above-described first control instruction, the second control instruction is not determined over the given period of time but is determined accordingly based on the measured output power of the wind turbine 2 and the long-period component.

The first control instruction and the second control instruction, determined by the first-control-instruction generating section 13 and the second-control-instruction generating section 14, are output by the transmission section 15 to the control unit 34 of the pumped-storage power generation facility 3 and the control unit 43 of the power storage facility 4, respectively.

In the pumped-storage power generation facility 3, the control unit 34 controls the pump 31 based on the schedule information of the first control instruction received from the central control unit 5, thereby performing electric power consumption or electric power supply according to the first control instruction. Specifically, when the first control instruction is an instruction to consume electric power, the pump 31 is driven to move water in the lower reservoir 32 to the upper reservoir 33, thus consuming the output power of the wind turbine 2. When the first control instruction is an instruction to supply electric power, electric power generated by dropping water stored in the upper reservoir 33 into the lower reservoir 32 is supplied to the interconnecting point A.

Thus, control is performed such that the long-period variation component of the wind turbine 2, such as that shown in FIG. 6 or FIG. 7, matches the target output power, thus making it possible to level the long-period output-power variation in the wind turbine 2.

In the power storage facility 4, the control unit 43 controls the electric power conversion system 42 based on the second control instruction received from the central control unit 5, thereby performing charging or discharging according to the second control instruction. Specifically, when the second control instruction is an instruction to consume electric power, the electric storage device 41 is charged with the output power of the wind turbine 2 via the electric power conversion system 42. When the second control instruction is an instruction to supply electric power, the electric power stored in the electric storage device 41 is discharged via the electric power conversion system 42, thus supplying the electric power to the interconnecting point A.

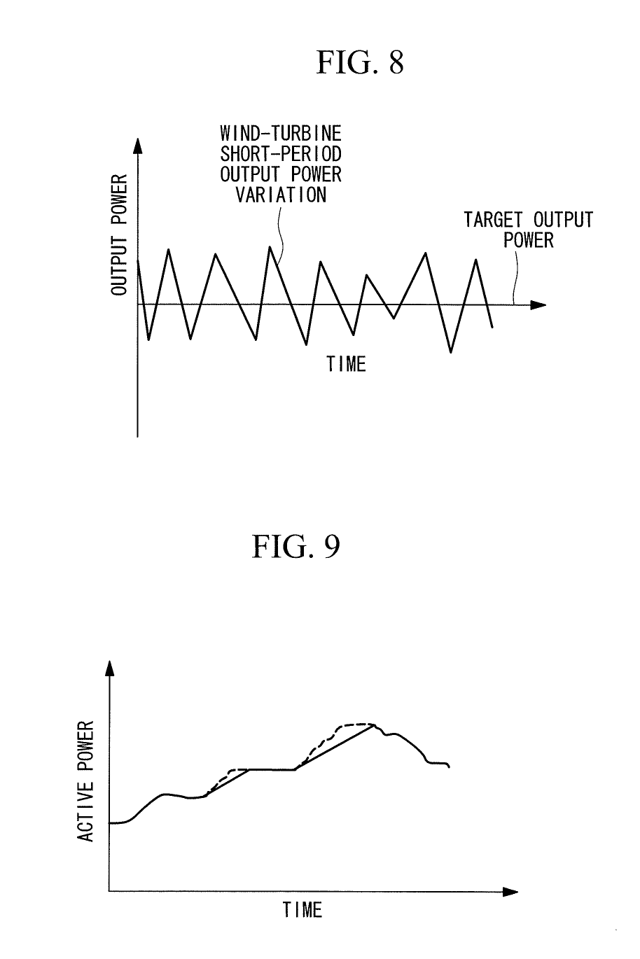

Thus, control is performed such that the short-period variation component of the wind turbine 2, such as that shown in FIG. 8, matches the target output power, thus making it possible to level the short-period output-power variation in the wind turbine 2.

In the generator system 1, having such a configuration, the following control is repeatedly performed by the central control unit 5.

First, wind-condition prediction information is input to the wind-turbine output-power predicting section 11 of the central control unit 5, and a prediction of the output power of the wind turbine 2 is obtained from this wind-condition prediction information. Then, in the long-period-component extracting section 12, a long-period component is extracted from the prediction of the output power of the wind turbine 2, and is output to the first-control-instruction generating section 13 and the second-control-instruction generating section 14.

In the first-control-instruction generating section 13, schedule information of the first control instruction is determined from the long-period component and the target output power, and is sent to the control unit 34 of the pumped-storage power generation facility 3 via the transmission section 15.

In the second-control-instruction generating section 14, the long-period component and the measured output power of the wind turbine 2 are input, and a second control instruction is determined from these pieces of information. The second control instruction is sent to the control unit 43 of the power storage facility 4 via the transmission section 15.

Thus, the pumped-storage power generation facility 3 is controlled based on the schedule information of the first control instruction, and the power storage facility 4 is controlled based on the second control instruction.

As described above, according to the generator system 1 of this embodiment, the output power of the wind turbine 2 is predicted from the wind-condition prediction information about the area where the wind turbine is installed; the long-period output-power variation component is extracted from the output power prediction; the first control instruction for leveling the long-period output-power variation is determined, and sent to the pumped-storage power generation facility 3; and the second control instruction for leveling the short-period output-power variation, which is obtained by subtracting the long-period output-power variation from the measured output power of the wind turbine 2, is determined, and sent to the power storage facility 4.

In this way, since the pumped-storage power generation facility 3 and the power storage facility 4 are controlled based on the first control instruction and the second control instruction, respectively, it is possible to level the short-period and long-period output power variations in the wind turbine and to stably supply electric power to the utility grid 6.

Furthermore, compared with the pumped-storage power generation facility 3, the power storage facility 4 has a higher response speed and is excellent in leveling the short-period output power variation. Furthermore, compared with the power storage facility 4, the pumped-storage power generation facility 3 has a larger capacity and is excellent in leveling the large output power variation.

Therefore, the power storage facility 4 is used for leveling the short-period output power variation, and the pumped-storage power generation facility 3 is used for leveling the long-period output power variation, thus realizing leveling of the output power variation by using an electric power generation facility having appropriate responsiveness and an appropriate scale. Thus, it is possible to reduce the cost of the system, compared with a conventional case in which leveling of long-period and short-period variations is performed by a power storage facility alone.

Furthermore, since the pumped-storage power generation facility 3 is controlled based on the schedule information of the first control instruction, it is possible to grasp estimated time and the required amount of water for electric power generation, in advance. Thus, for example, the required amount of water is moved to the upper reservoir 33 in advance according to the schedule information, thereby making it possible to reduce electric power consumption required to move excess water.

In the generator system 1 of this embodiment, in which the pumped-storage power generation facility 3 is controlled based on the schedule information of the first control instruction, when the actual output power of the wind turbine 2 is different from the predicted output power of the wind turbine, the difference therebetween is absorbed by the power storage facility 4 (see Formula (2)).

However, when the actual output power of the wind turbine 2 is significantly different from the predicted output power of the wind turbine, the second control instruction calculated based on Formula (2) exceeds the capacity of the power storage facility 4, and the power storage facility 4 cannot absorb the variation. In this case, the output power of the wind turbine may be predicted again; the schedule information of the first control instruction for the pumped-storage power generation facility 3 may be determined again; and the new schedule information of the first control instruction may be output to the pumped-storage power generation facility 3.

In this embodiment, the wind-turbine output power is predicated based on the wind-condition prediction information; however, the prediction is not limited thereto. For example, the prediction may be performed such that the wind-turbine output power to be obtained at several minutes or several tens of minutes from the present time is predicted from a past wind-turbine output-power record, the long-period component is extracted based on this prediction result, and the above-described control of the pumped-storage power generation facility 3 and the power storage facility 4 is performed by using this long-period component.

Furthermore, in this embodiment, the pumped-storage power generation facility 3 is used for leveling the long-period variation in the wind turbine 2; however, such as an electric power generation facility that can intentionally vary the output power produced by thermal electric power generation may be used as a variable-output-power generation facility.

Furthermore, in this embodiment, the power storage facility 4 is used for leveling the short-period output power variation; however, so-called “gradient power control (ramp rate control)” in the wind turbine may be adopted instead.

This “gradient power control” is a control method specified in Item b of Section C.2 in IEC 6140025-2 and is used to suppress the short-period output power variation in the wind turbine, as shown in FIG. 9.

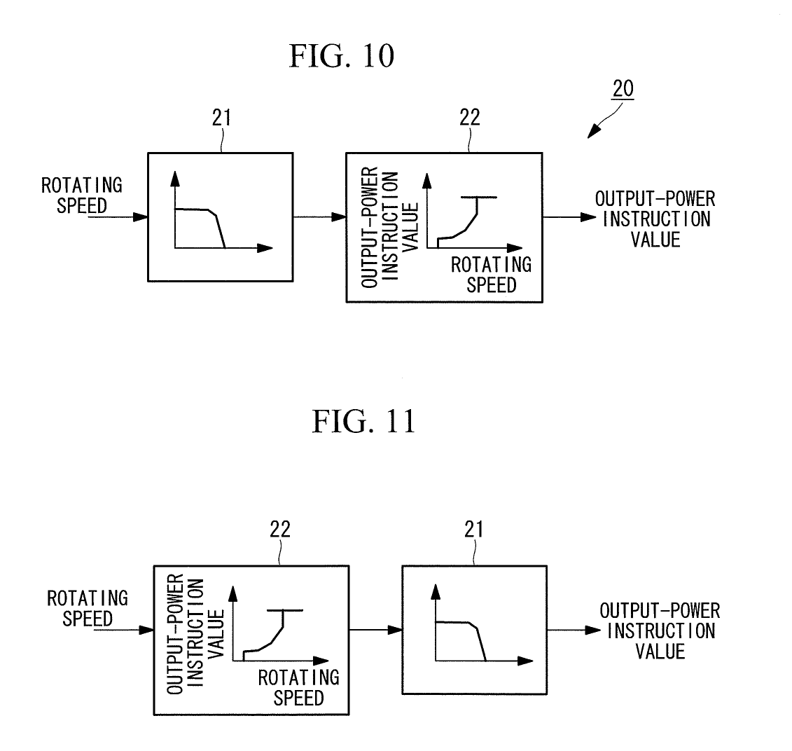

FIG. 10 is a functional block diagram of a wind-turbine control unit 20 that adopts the gradient power control. As shown in FIG. 10, a low-pass filter (variation suppressing section) 21 is provided in the process for determining an output-power instruction value from the rotating speed, thus suppressing the variation in the output-power instruction value. Specifically, the wind-turbine control unit 20 includes the low-pass filter 21 and a rotational-speed/output-power conversion table 22.

In the wind-turbine control unit 20, having such a configuration, the shaft rotating speed of the wind turbine 2 or the rotor rotating speed of a generator is leveled by making it pass through the low-pass filter 21, and an output-power instruction value corresponding to the leveled rotating speed is determined by using the rotating-speed/output-power conversion table 22. The determined output-power instruction value is output to a generator control unit (not shown) and a pitch-angle control unit (not shown), and the generator and the blade pitch angle are controlled.

For example, in the gradient power control, the rotating speed, which is input information, is leveled by making it pass through the low-pass filter, and the output-power instruction value is set based thereon; thus, a situation in which the wind-turbine output power is not increased accordingly even though the rotating speed is increased is likely to occur. In this case, excess energy is used to increase the rotating speed of the rotor, and, at this time, the pitch angle is controlled to prevent the occurrence of over speed.

As described above, the short-period output power variation is leveled through the control of the wind turbine, instead of the power storage facility 4, thereby making it possible to eliminate the power storage facility 4 and to achieve simplification of the system.

Instead of the configuration shown in FIG. 10, for example, the low-pass filter 21 may be provided at the subsequent stage of the rotating-speed/output-power conversion table 22, as shown in FIG. 11.

Furthermore, a rate limiter (a variation suppressing section) may be used instead of the above-described low-pass filter 21. In this case, the rate limiter can be provided at the position of the low-pass filter 21 shown in FIG. 10 or FIG. 11. It is desirable to set the value of the rate limiter to a rate of change (for example, about 200 kW/s) that contributes to suppression of the short-period variation.

Furthermore, in the above-described example, the output-power instruction value is determined based on the rotating speed; however, instead of this, the output-power instruction value may be determined based on the wind speed. In this case, a wind-speed/output-power conversion table in which the wind speed is associated with the output-power instruction value is used instead of the rotating-speed/output-power conversion table 22.

### REFERENCE SIGNS LIST

1 generator system
2 wind turbine
3 pumped-storage power generation facility
4 power storage facility
5 central control unit
6 utility grid
20 wind-turbine control unit
21 low-pass filter
22 rotating-speed/output-power conversion table
31 pump
32 lower reservoir
33 upper reservoir
34, 43 control unit
41 electric storage device
42 electric power conversion system

1. A generator system comprising:
a wind turbine;
a variable-output-power generation facility for leveling an output power variation having a long period in the wind turbine;
a power storage facility for leveling an output power variation having a short period in the wind turbine; and
a central control unit that gives control instructions to the wind turbine, the variable-output-power generation facility, and the power storage facility,
wherein the output power of the wind turbine, the output power of the variable-output-power generation facility, and the output power of the power storage facility are supplied to a common utility grid; and
the long period is a period of several minutes or more, and the short-period is a period shorter than the long period.

2. A generator system according to claim 1, wherein the central control unit extracts a long-period component from an output power prediction for the wind turbine and outputs a first control instruction for leveling the extracted long-period component to the variable-output-power generation facility.

3. A generator system according to claim 2, wherein the central control unit outputs, to the variable-output-power generation facility, schedule information of the first control instruction, in which time is associated with the first control instruction over a predetermined period of time.

4. A generator system according to claim 2, wherein the central control unit obtains wind-condition prediction information about an area where the wind turbine is installed and obtains the output power prediction for the wind turbine from the wind-condition prediction information.

5. A generator system according to claim 2, wherein the central control unit calculates a second control instruction by subtracting the long-period component from measured output power of the wind turbine and outputs the second control instruction to the power storage facility.

6. A generator system according to claim 5, wherein, when the second control instruction exceeds a capacity of the power storage facility, the central control unit makes an output power prediction for the wind turbine again, generates schedule information of the first control instruction again, and outputs the determined schedule information of the first control instruction to the variable-output-power generation facility.

7. A generator system according to claim 1, wherein the variable-output-power generation facility is a pumped-storage power generation facility.

8. A generator system comprising:
a wind turbine that has a function for suppressing an output power variation having a short period;
a variable-output-power generation facility for leveling an output power variation having a long period in the wind turbine; and
a central control unit that gives control instructions to the wind turbine and the variable-output-power generation facility,
wherein the output power of the wind turbine and the output power of the variable-output-power generation facility are supplied to a common utility grid; and
the long period is a period of several minutes or more, and the short-period is a period shorter than the long period.

9. A generator system according to claim 8,
wherein the wind turbine comprises a wind-turbine control unit that determines an output-power instruction value based on a rotating speed or a wind speed; and
the wind-turbine control unit comprises a variation suppressing section that suppresses a variation in the output-power instruction value to within an allowable range.
